(19) United States
(12) Patent Application Publication
(10) Pub. No.: US 2020/0207168 A1
(43) Pub. Date: Jul. 2, 2020

(54) Drawbar with Safety Mechanism and Latching in Position

(71) Applicant: LOHR ELECTROMECANIQUE, Hangenbieten (FR)

(72) Inventors: Daniel Scheer, Still (FR); Didier Ganter, Fegersheim (FR); Jean-Luc Andre, Molsheim (FR); Nicolas Sutter, Strasbourg (FR)

(21) Appl. No.: 16/614,903

(22) PCT Filed: Jun. 8, 2018
(86) PCT No.: PCT/EP2018/065187

§ 371 Date: Nov. 19, 2019

(30) Foreign Application Priority Data
Jun. 16, 2017 (FR) 1755524

(51) Int. Cl. B60D 1/42; B60D 1/48; B60D 1/155

(52) U.S. Cl. CPC B60D 1/42; B60D 1/155; B60D 1/481

(57) ABSTRACT

The drawbar comprises a main cylinder with a moving rod equipped with a coupling ring for coupling same to a second vehicle. The drawbar comprises a latching device with safety ratchet which is automatically activated by latching in the event of failure of said main cylinder, in order to prevent the exit of the moving rod. The drawbar is mounted to pivot with respect to the road vehicle to which it is fitted and further comprises an immobilisation device provided to prevent any pivoting of the drawbar when the movable rod of said drawbar is in the retracted position.

### TECHNICAL FIELD

The present invention relates to a drawbar comprising a cylinder and intended to be mounted on a road vehicle in order to allow coupling thereof with another road vehicle.

More specifically, the invention relates to a drawbar that is mobile relative to the vehicle that it equips at least along a lateral travel range in the horizontal plane or along a vertical travel range in the vertical plane.

### BACKGROUND OF THE DISCLOSURE

The drawbar from the invention is specific in that it comprises a longitudinal cylinder with mobile rod whose distal end comprises a coupling part, for example a ring, a ball or a coupling hook, intended to be latched with a complementary coupling part of another vehicle in order to couple said two vehicles.

In case of failure of the cylinder of the drawbar, the mobile rod thereof is then floating, which is not safe for the coupling of the two vehicles.

The drawbar from the invention is also specific in that it is mobile relative to the vehicle that it equips along at least one lateral or vertical travel range. When the distal end of the drawbar is latched with another vehicle, the two vehicles are coupled and the means of lateral and/or vertical travel range of the drawbar allow some degree of movement of one vehicle relative to the other, for example a yaw and/or pitch as is known for coupling devices.

When the distal end of the drawbar is not latched with another vehicle, the drawbar is free in the movements thereof relative to the vehicle that it equips. Although the amplitude of these movements is preferably limited by stops, the lateral and/or vertical swinging of the drawbar when the vehicle is moving causes disagreeable shaking and the shocks that occur could damage the drawbar and the vehicle that it equips. Further, in case of travel of the vehicle over a pothole or a speed bump, the drawbar could hit the ground, which could severely damage the drawbar and the vehicle that it equips. Finally, the free movements of the drawbar are not safe and do not allow knowledge at each moment of the position in which the drawbar is located.

These problems become even more critical in the case where the drawbar has a long length. In fact the drawbar from the invention is specific in that it preferably extends substantially from the front axle of the vehicle out in front of the vehicle such that the coupling ring which for example equips the distal end of the drawbar is projecting from the front of the vehicle.

A towing device for an agricultural or industrial vehicle is known from EP 1,974,963 which comprises a lower chassis having an extendable part equipped with a coupling ball. A lug longitudinally immobilizes the extendable part by engaging in a housing of the fixed chassis. However, this lug is not actuated automatically in latching in case of failure of the actuator which moves the extendable part of the chassis longitudinally.

A telescopic towbar of adjustable length in order to be able to adapt to the distance between the towing vehicle and the pulled vehicle is known from U.S. Pat. No. 2,693,368. The longitudinal movement of the two telescopic parts of the towbar can be latched by a ratchet effect device which can be manually unlatched. This document D2 does not however disclose any cylinder and the operation of the telescopic towbar is entirely manual.

Consequently, there is a need for a drawbar with which to address the problems previously raised.

### SUMMARY OF THE DISCLOSURE

In the domain of drawbars equipped with a cylinder with mobile rod for which the free end is equipped with a coupling part, the purpose of the present invention consequently aims at remedying the disadvantages of the prior art by proposing a new drawbar comprising a security device which prevents the extension of the mobile rod of the cylinder in case of failure thereof.

Such a cylinder may for example be a pneumatic, hydraulic or electric cylinder.

Advantageously, the security device must be automatic, must operate without energy, must not prevent the retracting of the mobile rod of the cylinder, and must allow the extension of the mobile rod of the cylinder when said cylinder is actuated in extension by pressurization thereof or electric supply thereto.

Another object of the present invention also aims to propose a new drawbar comprising a device with which to immobilize it in position when it is not coupled to another vehicle.

Another object of the present invention also aims to propose a new drawbar equipped with an immobilization device with which to raise the free end of the drawbar when it is immobilized, in order to avoid it touching the ground when crossing a pothole or speed bump.

Advantageously, this immobilization device is motorized by the cylinder of the drawbar.

The objectives assigned to the invention are achieved by using a road vehicle equipped with a drawbar for coupling thereof with a second road vehicle characterized in that the drawbar comprises the following means:

a main cylinder arranged longitudinally in the drawbar and comprising a rod mobile between a retracted position, an extended position and an intermediate position included between the retracted position and the extended position;

a coupling part provided at the free end of the mobile rod of the main cylinder, where said coupling part is able to couple said vehicle to the second road vehicle by latching thereof with a complementary coupling part;

a latching device that is actuated automatically in latching in case of failure of said main cylinder, where the latching device prevents the extension of the mobile rod of the main cylinder when it is actuated in latching.

Thus, thanks to the invention, the coupling is secured, even in case of failure of the main cylinder. Further, the latching device according to the invention is only active when the main cylinder fails, which serves to control the distance between the coupled vehicles continuously in normal operation, and not only according to discrete stroke values.

According to an example of implementation of the invention, the latching device comprises a latching assembly secured to the drawbar and intended to engage in mutual latching with a complementary latching assembly secured to the mobile rod of the main cylinder when the mobile rod is in an intermediate position in order to prevent the movement of said mobile rod of the main cylinder in extended position.

According to another example of implementation of the invention, the latching assembly comprises a safety ratchet mounted on the drawbar mobile between a latching position preventing displacement of the mobile rod of the main cylinder when said mobile rod is in an intermediate position and a retracted position in which it is passive and allows displacement of the mobile rod.

The advantage of a ratchet is that it allows the retracting movement of the mobile rod, but it blocks it in extension when it is in intermediate position.

According to an additional example of implementation of the invention, the latching assembly comprises a holding mechanism which constrains the safety ratchet in latching position when the mobile rod of the main cylinder is immobile or moves in the direction of the extended position, and which allows the automatic movement of the safety ratchet in retracted position when the mobile rod of the main cylinder moves in direction of the retracted position.

According to an example of implementation of the invention, the holding mechanism comprises an elastic return or pushing device which constrains the safety ratchet in latching position.

According to another example of implementation of the invention, the holding mechanism comprises a secondary cylinder which moves the safety ratchet into retracted position when it is actuated, where a chamber of said secondary cylinder is in fluid communication with a chamber of the main cylinder or the electrical control of the secondary cylinder is subject to that of the main cylinder such that when the main cylinder is actuated for extending the mobile rod, the secondary cylinder associated with the security ratchet is also actuated.

By making the secondary cylinder of the safety ratchet subject to the main cylinder, the rod of the cylinder can be automatically unlatched when the user wishes to move it into extended position.

According to a supplemental example of implementation of the invention, the safety ratchet comprises a latching finger, and the complementary latching assembly secured to the mobile rod of the main cylinder comprises a receiving opening intended to receive the latching finger in latching position.

According to an example of implementation of the invention, the drawbar is mounted pivoting relative to the road vehicle that it equips in a horizontal plane and/or in a vertical plane, and it further comprises an immobilization device intended to prevent any pivoting of the drawbar when the mobile rod of said drawbar is in retracted position.

Thus, thanks to the invention, the drawbar is immobilized when it is not used.

According to another example of implementation of the invention, the immobilization device comprises:

a first immobilization element fixed to the road vehicle;

a second immobilization element fixed to the drawbar and intended to engage for mutual latching with said first immobilization element when the mobile rod of the main cylinder is moved into retracted position;

said drawbar being immobilized in position when the first and second immobilization elements are mutually latched.

According to another implementation of the invention, the second immobilization element is mounted pivoting on the drawbar between a latching position in which it is engaged for latching with the first immobilization element, and a second unlatched position in which it is not engaged for latching with the first immobilization element, and the immobilization device comprises:

a cam connected to the mobile rod of the main cylinder and a second immobilization element; or

a projecting part provided on the mobile rod of the main cylinder and coming into contact with the second immobilization element when said mobile rod is displaced into retracted position;

said cam or projecting part making the second immobilization element pivot into the latching position when the mobile rod of the cylinder is displaced into retracted position.

Thus, the drawbar is automatically immobilized during movement into retracted position of the mobile rod of the main cylinder.

According to an additional example of implementation of the invention, the first immobilization element is provided under the road vehicle and the second immobilization element is provided in the upper part of the drawbar.

According to an example of implementation of the invention, the first and second immobilization elements are for the one a claw or hook and for the other a hasp or hanger, where said first and second immobilization elements are intended to be engaged in mutual latching when the mobile element of said drawbar is in retracted position.

According to another example of implementation of the invention, the immobilization device comprises an elastic pushing or return device which constrains the second immobilization element in unlatched position.

The objects assigned to the invention are also achieved by means of a road vehicle such as previously described, characterized in that it comprises:

a drawbar at the front or rear end of the road vehicle and comprising a coupling part;

a coupling yoke provided at the other end of the road vehicle and comprising a complementary coupling part;

the coupling part of the road vehicle being able to mutually latch with a complementary coupling part of another road vehicle, and said complementary coupling part of the road vehicle being able to mutually latch with the coupling part of another road vehicle.

According to another of implementation of the invention, said road vehicle comprises a drawbar in the front and a coupling yoke in the back.

### BRIEF DESCRIPTION OF THE DRAWINGS

Other features and advantages of the invention will become clearer in reading the description that follows, made in reference to the attached figures, given by way of non-limiting examples, wherein:

FIG. 1 is a three-quarter rear bottom perspective view of two road vehicles equipped with a coupling device comprising a drawbar according to the invention, where these two road vehicles are not coupled;

FIG. 2 is a perspective view similar to that of FIG. 1, in which the two road vehicles are coupled;

FIG. 3 is a three-quarter front bottom perspective view of a road vehicle equipped with a drawbar according to the invention;

FIG. 4 is a three-quarter front top perspective view of a drawbar according to the invention;

FIGS. 5 and 6 are longitudinal horizontal section views of a drawbar according to the invention, where these figures show the operation of the safety ratchet from the invention;

FIGS. 7 and 8 are detailed views of the parts respectively circled on FIGS. 5 and 6; and

FIGS. 9 to 11 are longitudinal vertical section views of a drawbar according to the invention, where these figures show the steps of latching said drawbar in position.

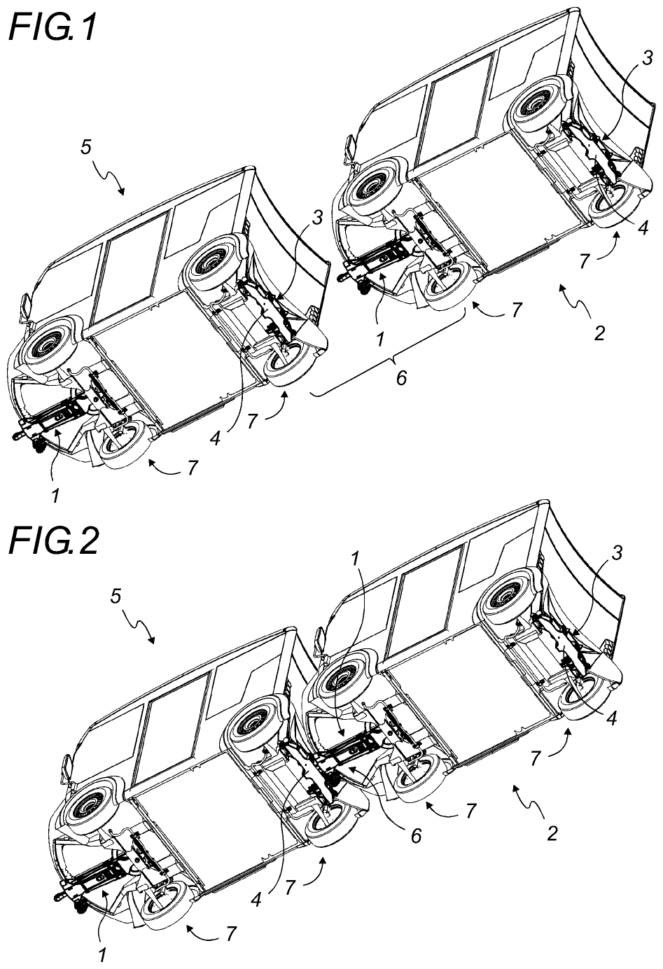

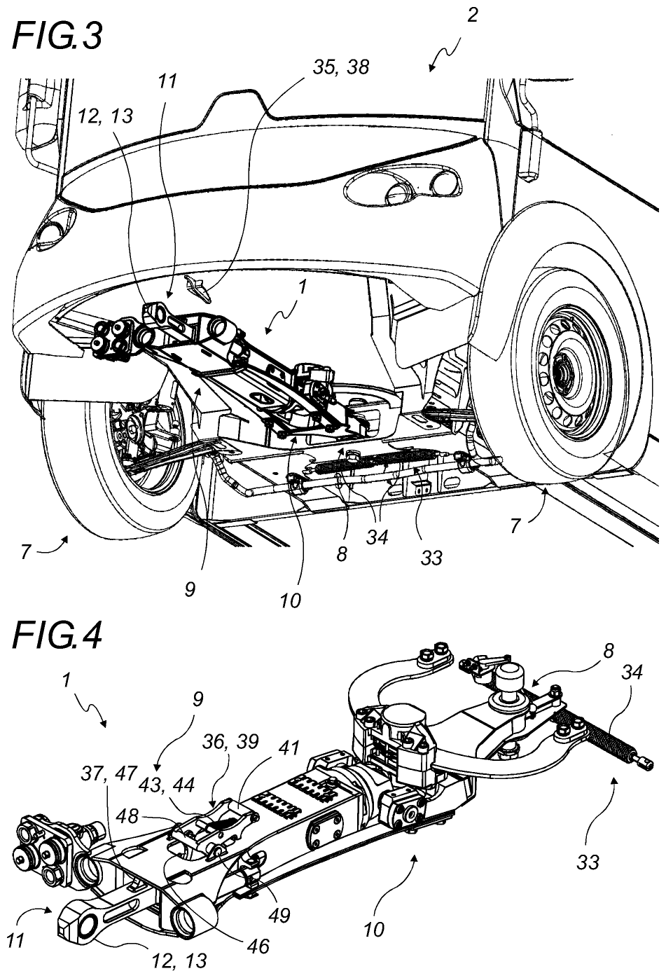

### DETAILED DESCRIPTION

The structurally and functionally identical elements shown in several different figures are assigned the same numerical or alphanumerical reference.

The drawbar (1) according to the invention is preferably intended to be mounted on a first motor vehicle (2) in order to be, for example, received in a coupling yoke (3) secured to the crossbar (4) of the second road vehicle (5) in order to couple these two road vehicles (2, 5).

The drawbar (1) according to the invention and the coupling yoke (3) are consequently part of a coupling device (6) which allows to couple two road vehicles (2, 5).

The expressions “first vehicle” and “second vehicle” do not translate into any relative positioning nor any role for these vehicles, but simply allows distinguishing them from each other.

According to a preferred embodiment of the invention, the second road vehicle (5) is a motorized towing vehicle which is positioned in front of the first road vehicle (2) which is a following vehicle.

The road vehicles (2, 5) preferably each comprise at least two axles (7) and are intended to transport people.

According to a preferred embodiment of the invention, the first and second road vehicles (2, 5) are identical, and intended to form couplings of at least two road vehicles (2, 5) in a row one after the other in order to form a road train. Thus, the invention also relates to a unitary road vehicle (2) comprising a drawbar (1) according to the invention provided at one front or rear end of the road vehicle (2), for example at the front of said vehicle (2), and a coupling yoke (3) provided at the opposite end, for example at the rear of said vehicle (2).

The drawbar (1) according to the invention is preferably mounted rotating by the proximal end thereof (8), substantially near the front axle (7) of the vehicle (2, 5) equipped with said drawbar (1), which allows a yawing travel range of the road vehicles (2, 5) coupled to each other.

Preferably, the drawbar (1) according to the invention also comprises a joint allowing the distal part thereof (9) to pivot vertically relative to the proximal part (10) thereof and therefore relative to the vehicle (2, 5) equipped with said drawbar (1).

The distal end (11) of the drawbar (1) comprises a coupling part (12) engageable with a complementary coupling part of another vehicle (5) in order to couple the road vehicles (2, 5).

Here coupling part (12) is understood to mean a male or female coupling part intended to be latched with a complementary female or male coupling part provided on the second road vehicle (5). Several forms can be conceived for the coupling part (12) without going outside the scope of the invention. For example, the coupling part (12) can have the form of a coupling ring (13), but also that of a hook, a perforated plate, a part having a recess, a rod, a hitching ball, etc.

In the figures, the drawbar (1) comprises a coupling part (12) in the shape of a coupling ring (13) provided near the distal end (11) thereof, whereas the coupling yoke (3) of the second road vehicle (5) comprises a receiving housing (8) in which said coupling ring (13) is intended to be received and latched in order to couple the two road vehicles (2, 5).

The drawbar (1) according to the invention comprises a main cylinder (14) arranged longitudinally in the drawbar and comprising a mobile rod (15).

The coupling part (12) is provided at the free end of the mobile rod (15) of the main cylinder (14).

The mobile rod (15) of the main cylinder (14) is displaceable between a retracted position, an extended position and an intermediate position included between the retracted position and the extended position. The retracted position of the mobile rod (15) also corresponds to a retracted position of the coupling part (12), and likewise the extended position of the mobile rod (15) also corresponds to an extended position of the coupling part (12). When the vehicle (2) equipped with the drawbar (1) according to the invention is not coupled, the mobile rod (15) of the main cylinder (14) is moved into retracted position.

The main cylinder (14) serves in particular for extending and retracting the coupling part so as to retract it under the vehicle (2) when it is not needed, for example when the vehicle (2) travels as a single vehicle, and to deploy it when the vehicle (2) must be coupled to a second road vehicle (5).

Once the coupling is done, the main cylinder (14) also serves to bring the coupled vehicles (2, 5) closer.

When the road vehicle (2) that it equips is coupled to a second road vehicle (5), the main cylinder (14) is pressurized or supplied with electricity such that the mobile rod (15) thereof exerts a traction on the second road vehicle (5) and that the coupling yoke (3) of the second road vehicle (5) is firmly pressed against the front surface of the drawbar (1). This energy supplied to the main cylinder (14) thus serves to stiffen the coupling device (6).

In order to avoid any risk of separation of the coupled vehicles (2, 5) in case of failure of the main cylinder (14), the drawbar (1) according to the invention comprises a latching device (16) which prevents the extension of the mobile rod (15) of the main cylinder (14) in case of loss of pressure in said main cylinder (14), failure of the electric supply of the main cylinder (14) or failure of the general operation of the main cylinder (14).

This latching device (16) is automatically actuated in latching of the mobile rod (15) in case of failure of the main cylinder (14).

Preferably, the latching device (16) is no longer actuated for latching of the mobile rod (15) when the main cylinder (14) is pressurized or supplied with electricity in order for extending the mobile rod (15) thereof.

As shown on FIGS. 5 to 8, the latching device (16) comprises a latching assembly (17) secured to the drawbar (1) and intended to engage in mutual latching with a complementary latching assembly (18) secured to the mobile rod (15) of the main cylinder (14) when the mobile rod (15) is in an intermediate position in order to prevent the movement of said mobile rod (15) of the main cylinder (14) in extended position.

According to one preferred embodiment of the invention, the latching assembly (17) comprises a safety ratchet (19) mounted on the drawbar (1) mobile between a latching position preventing displacement of the mobile rod (15) of the main cylinder (14) when said mobile rod (15) is in an intermediate position and a retracted position in which it is passive and allows displacement of the mobile rod (15).

In FIGS. 5 to 8 given as an example, the safety ratchet (19) is provided pivoting on the drawbar (1) in a horizontal plane, with a latching finger (20) intended for being received in a complementary latching assembly (18) having the form of a receiving opening (21) provided in a guiding part (22) secured to the mobile rod (15) of the main cylinder (14).

The latching assembly (17) preferably comprises a holding mechanism (23) which constrains the safety ratchet (19) in latching position when the mobile rod (15) of the main cylinder (14) is immobile or moves in the direction of the extended position, and which allows the automatic movement of the safety ratchet (19) in retracted position when the mobile rod (15) of the main cylinder (14) moves in direction of the retracted position.

According to the example shown in the figures, the holding mechanism (23) comprises an elastic return or pushing device (24) which constrains the safety ratchet (19) in latching position. This elastic return or pushing device (24) may have the form of a coil spring (25).

The holding mechanism (23) preferably comprises a secondary cylinder (26) which moves the safety ratchet (19) into retracted position when it is actuated. This secondary cylinder (26) is preferably a single acting cylinder.

In the case where the secondary cylinder (26) is a pneumatic or hydraulic cylinder, a chamber (27) of said secondary cylinder (26) is preferably in fluid communication with a chamber (28) of the main cylinder (14) such that when the main cylinder (14) is actuated for extending the mobile rod (15), the secondary cylinder (26) associated with the safety ratchet (19) is also actuated.

Similarly in the case where the secondary cylinder (26) is an electric cylinder, the electric control of the secondary cylinder (26) is preferably subject to that of the main cylinder (14) such that when the main cylinder (14) is actuated for extending the mobile rod (15), the secondary cylinder (26) associated with the safety ratchet (19) is actuated to move it into retracted position.

A preferred embodiment of the latching device (16) given here as an example in order to better understand the operation of said device from the invention is shown on FIGS. 5 to 8. In this example, the main cylinder (14) is a double acting cylinder. Pressurizing the proximal chamber thereof (28) causes the extension of the mobile rod (15), whereas pressurizing the distal chamber (29) thereof causes the retratcting of the mobile rod (15).

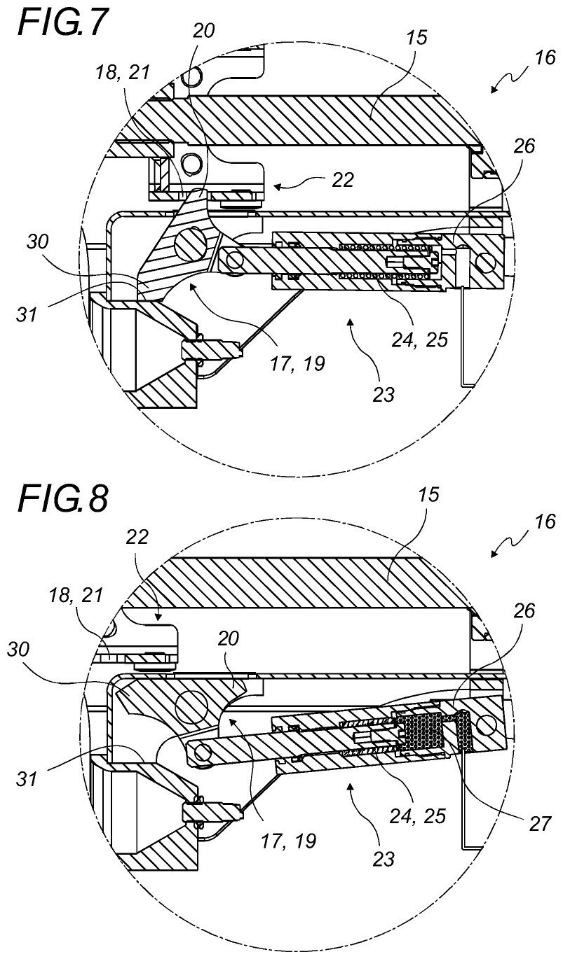

On FIGS. 5 and 7, the latching device (16) from the invention is in latching position, in which the latching finger (20) of the safety ratchet (19) is engaged in the receiving opening (21) provided in the guiding part (22) secured to the mobile rod (15) of the main cylinder (14). In this position, the part (30) of the safety ratchet (19) which is opposite the latching finger (20) is bearing on a receiving surface (31) securely fixed to the drawbar (1). Bearing this way prevents the safety ratchet (19) from pivoting backwards and consequently prevents the extension of the mobile rod (15) from the main cylinder (14) while allowing the retracting thereof. In this position, the spiral spring (25) is deformed and tends to push the latching finger (20) into engaging in the receiving opening (21).

On FIG. 5, the distal chamber (29) of the main cylinder (14) is pressurized, which retracts the mobile rod (15) of the main cylinder (14). This movement pivots the safety ratchet (19) clockwise such as shown on the figures. The latching finger (20) leaves the receiving opening (21) and the part (30) of the safety ratchet (19) opposite the latching finger (20) is no longer bearing on the receiving surface (31). The mobile rod (15) of the main cylinder (14) is free to slide.

During the retracting of the mobile rod (15) of the main cylinder (14), the coil spring (25) pushes the latching finger (20) towards the mobile rod (15), thus once the receiving opening (21) comes opposite the latching finger (20), said latching finger (20) automatically engages for latching in the receiving opening (21).

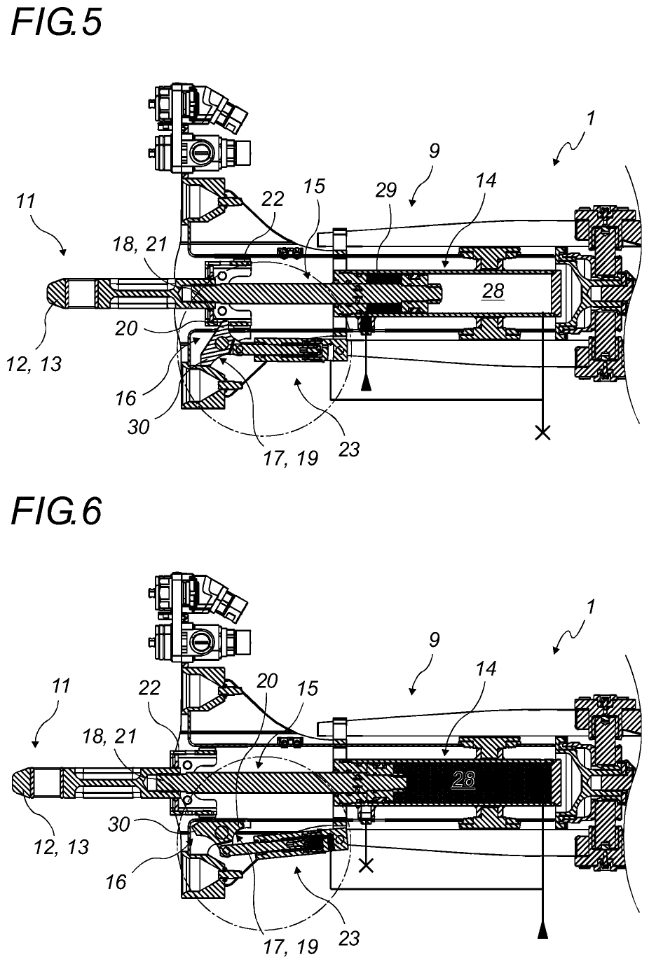

On FIG. 6, that is the proximal chamber (28) of the main cylinder (14) which is pressurized, which extends the mobile rod (15) of the main cylinder (14). Because the chamber (27) of the secondary cylinder (26) is in fluid connection with the proximal chamber (28), said secondary cylinder (26) also moves the latching finger (20) into retracted position. If the latching finger (20) were engaged in the receiving opening (21), it is then moved outside thereof.

In this position shown on FIGS. 6 and 8, the mobile rod (15) of the main cylinder (14) can freely slide in extension.

It will be noted that in case of hydraulic or pneumatic failure the mobile rod (15) of the main cylinder (14) is blocked extended by the automatic placement of the latching finger (20) in latched position, which constitutes a positive safety device for the latching device (16) of the invention.

According to a preferred embodiment of the invention, the drawbar (1) is mounted pivoting relative to the road vehicle (2) that it equips in a horizontal plane and/or in a vertical plane.

In order to immobilize it when it is no longer needed for coupling to another vehicle, the drawbar (1) comprises an immobilization device (32). This immobilization device (32) is intended to prevent any pivoting of the drawbar (1) when the mobile rod (15) of said drawbar (1) is in retracted position.

According to a preferred embodiment of the invention, the drawbar (1) also comprises a centering device (33) intended to retract the drawbar (1) into central position in the horizontal plane when it is no longer needed for coupling to another vehicle. In fact, the drawbar (1) can become disengaged when the two road vehicles (2, 5) are not in the same axis, for example when there is a curve. Such a centering also makes it possible to place the drawbar (1) in a position suited for immobilization thereof by the immobilization device (32).

In the figures, the centering device (33) comprises two centering springs (34), one on each side of the drawbar (1), for centering the drawbar (1), when it is disengaged.

According to a preferred embodiment of the invention, the immobilization device (32) comprises a first immobilization element (35) fixed to the road vehicle (2) and a second immobilization element (36) fixed to the drawbar (1). Said first and second immobilization elements (35 and 36) are intended to engage for mutual latching when the mobile rod (15) of the main cylinder (14) is moved into retracted position, since the drawbar (1) is then immobilized in position when the first and second immobilization elements (35 and 36) are mutually latched. According to a preferred variant of the invention, the distal part (9) of the drawbar (1) is further pivoted upward by the immobilization device (32) when the first and second immobilization elements (35 and 36) are mutually latched.

According to a preferred embodiment of the invention, the second immobilization element (36) is mounted pivoting on the drawbar (1) between a latching position in which it is engaged for latching with the first immobilization element (35), and a second unlatching position in which it is not engaged for latching with the first immobilization element (35). The first immobilization element (35) is preferably shaped such that when it is engaged by the second immobilization element (36), it exerts a vertical force on the second immobilization element (36) directed upward, which makes the drawbar (1) pivot upward relative to the road vehicle (2) that it equips. Since the first immobilization element (35) has a thin free part, it also exerts a centering force on the drawbar (1).

In latched position of the immobilization device (32), the drawbar (1) is therefore not only held immobile under the vehicle structure (2), but it is also pressed upward so as to avoid any risk of collision between the drawbar (1) and any possible obstacle on the road. In FIG. 11, the drawbar (1) is thus raised 8° for a maximum ground clearance.

According to a variant of the invention not shown on the figures, the immobilization device (32) comprises a cam or a linkage system connected to the mobile rod (15) of the main cylinder (14) and to the second immobilization element (36), where said cam or linkage makes the second immobilization element (36) pivot into the latching position when the mobile rod (15) of the cylinder is moved in retracted position.

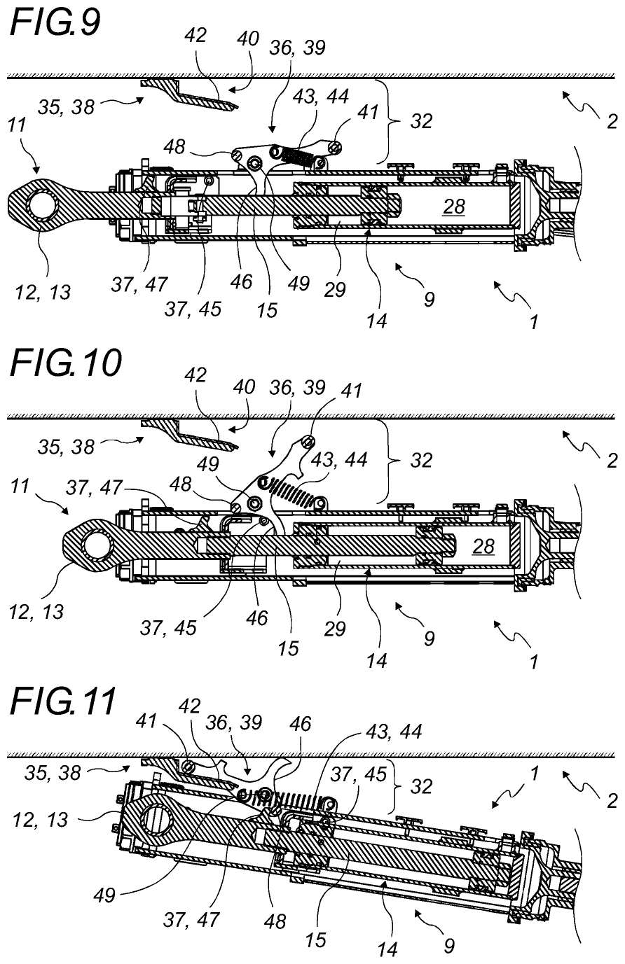

According to a preferred variant of the invention shown in FIGS. 9 to 11, the immobilization device (32) comprises at least one projecting part (37) provided on the mobile rod (15) of the main cylinder (14) and coming into contact with the second immobilization element (36) when said mobile rod (15) is moved into retracted position, where said projecting part (37) makes the second immobilization element (36) pivot into latched position when the mobile rod (15) of the main cylinder (14) is moved into retracted position.

As shown, as an example, in FIGS. 9 to 11, the first immobilization element (35) has the shape of a claw or hook (38) provided under the road vehicle (2), whereas the second immobilization element (36) has the form of a hasp or hanger (39) mounted pivoting on the upper part of the drawbar (1). The claw or hook (38) has a receiving opening (40) directed towards the rear of the road vehicle (2), where this receiving opening (40) is intended to receive an upper horizontal rod (41) provided in the area of the free end of the hasp or hanger (39), and where receiving of the upper horizontal rod (41) in the claw or hook (38) latches the drawbar (1) into position. The receiving opening (40) is preferably extended in the lower part thereof by an inclined ramp (42), which has the effect of raising the drawbar (1) upward while the upper horizontal rod (41) slides bearing on the upper surface of said inclined ramp (42) during pivoting of the clasp or hanger (39) to the latching position thereof.

The immobilization device (32) comprises an elastic pushing or return device (43) which constrains the second immobilization element (36) in unlatching position. As shown as an example in FIGS. 9 to 11, this elastic pushing or return device (43) has the shape of a coil spring (44) which pulls the second immobilization element (36) rearward, into position disengaged from the first immobilization element (35).

According to a preferred embodiment of the invention, the second immobilization element (36) is pivoted into position for immobilization of the drawbar (1) in several successive steps shown in FIGS. 9 to 11 during displacement of the mobile rod (15) of the main cylinder (14) into retracted position. These steps specific to the preferred embodiment of the invention are given here as an example in order to better understand the operation of the immobilization device (32) from the invention.

In FIG. 9, the mobile rod (15) is in partially extended position. The chamber of the main cylinder (14) shown to the left on the figures is pressurized in order to make the mobile rod (15) move back towards the right. The elastic pushing or return device (43) returns the second immobilization element (36) into disengaged position of the first immobilization element (35), for example pressed longitudinally against the main body of the drawbar (1).

In FIG. 10, the mobile rod (15) is in partially retracted position. A first projecting part (37, 45) provided on the mobile rod (15) comes to bear on a concave curved ramp (46) conforming to the lower part of the second immobilization element (36). During the retracting of the mobile rod (15), the pressing of the first projecting part (37, 45) on the concave curved ramp (46) causes the pivoting of the second immobilization element (36) by about one quarter of a turn. During this step, the elastic pushing or return device (43) tends to want to return the second immobilization element (36) into the position shown in FIG. 9.

A second projecting part (37, 47) provided on the mobile rod (15) then comes to bear on the second immobilization element (36), for example near a lower horizontal rod (48) when the second immobilization element (36) has the shape of a hasp or hanger (39) such as previously described. This bearing of the second projecting part (37, 47) on the second immobilization element (36) serves to further pivot the second immobilization element (36) in the direction of the engagement thereof with the first immobilization element (35) during the retracting of the mobile rod (15).

The upper horizontal rod (41) of the second immobilization element (36) then comes to slide on the inclined ramp (42) of the first immobilization element (35), which progressively raises the drawbar (1) as the retracting of the mobile rod (15) proceeds.

It will be noted that the kinematics of the movement of the second immobilization element (36) according to the invention results in particular because of the fact that the upper horizontal rod (41) and the lower horizontal rod (48) are eccentric relative to the axis of pivoting (49) of the second immobilization element (36) and preferably substantially opposed relative to said pivoting axis (49).

In FIG. 11, the mobile rod (15) is in fully retracted position. The second projecting part (37, 47) is always supporting the second immobilization element (36). The latter element is swung about a half turn relative to the position thereof shown in FIG. 9; the concave curved ramp (46) is now found towards the top. The second immobilization element (36) is then engaged with the first immobilization element (35) in immobilization position of the drawbar (1). The elastic pushing or return device (43) is strongly deformed and tends to want to return the second immobilization element (36) into the position shown in FIG. 9.

The release of the drawbar (1) is done by the inverse operations. During the extension of the mobile rod (15) of the main cylinder (14), the at least one projecting part (37) is no longer bearing on the second immobilization element (36) and it returns backwards along the main body of the drawbar (1) by the elastic pushing or return device (43) (see FIG. 9).

It is obvious that this description is not limited to the examples explicitly described, but also includes other embodiments and/or implementations. Thus, one described technical characteristic can be replaced by an equivalent technical characteristic without going outside the scope of the invention such as defined by the attached claims, and one described functional step of implementation of the method can be replaced by an equivalent step without going beyond the scope of the invention as defined by the claims.

1. A road vehicle equipped with a drawbar for coupling thereof with a second road vehicle wherein the drawbar comprises the following means:
a main cylinder arranged longitudinally in the drawbar and comprising a rod mobile between a retracted position, an extended position and an intermediate position included between the retracted position and the extended position;
a coupling part provided at the free end of the mobile rod of the main cylinder, where said coupling part is able to couple said vehicle to the second road vehicle by latching thereof with a complementary coupling part;
a latching device that is actuated automatically in latching in case of failure of said main cylinder, where the latching device prevents the extension of the mobile rod of the main cylinder when the latching device is actuated in latching.

2. The road vehicle according to claim 1, wherein the latching device comprises a latching assembly secured to the drawbar and intended to engage in mutual latching with a complementary latching assembly secured to the mobile rod of the main cylinder when the mobile rod is in an intermediate position in order to prevent the movement of said mobile rod of the main cylinder in extended position.

3. The road vehicle according to claim 2, wherein the latching assembly comprises a safety ratchet mounted on the drawbar mobile between a latching position preventing displacement of the mobile rod of the main cylinder when said mobile rod is in an intermediate position and a retracted position in which the safety ratchet is passive and allows displacement of the mobile rod.

4. The road vehicle according to claim 3, wherein the latching assembly comprises a holding mechanism which constrains the safety ratchet in latching position when the mobile rod of the main cylinder is immobile or moves in the direction of the extended position, and which allows the automatic movement of the safety ratchet in retracted position when the mobile rod of the main cylinder moves in direction of the retracted position.

5. The road vehicle according to claim 4, wherein the holding mechanism comprises an elastic return or pushing device which constrains the safety ratchet in latching position.

6. The road vehicle according to claim 4, wherein the holding mechanism comprises a secondary cylinder which moves the safety ratchet into retracted position when the secondary cylinder is actuated, where a chamber of said secondary cylinder is in fluid communication with a chamber of the main cylinder or the electrical control of the secondary cylinder is subject to that of the main cylinder such that when the main cylinder is actuated for extending the mobile rod, the secondary cylinder associated with the security ratchet is also actuated.

7. The road vehicle according to claim 3, wherein the safety ratchet comprises a latching finger, and wherein the complementary latching assembly secured to the mobile rod of the main cylinder comprises a receiving opening intended to receive the latching finger in latching position.

8. The road vehicle according to claim 1, wherein the drawbar is mounted pivoting relative to the road vehicle that the drawbar equips in a horizontal plane and/or in a vertical plane, and further comprising an immobilization device intended to prevent any pivoting of the drawbar when the mobile rod of said drawbar is in retracted position.

9. The road vehicle according to claim 8, wherein the immobilization device comprises:
a first immobilization element fixed to the road vehicle;
a second immobilization element fixed to the drawbar and intended to engage for mutual latching with said first immobilization element when the mobile rod of the main cylinder is moved into retracted position;
said drawbar being immobilized in position when the first and second immobilization elements are mutually latched.

10. The road vehicle according to claim 9, wherein the second immobilization element is mounted pivoting on the drawbar between a latching position in which the second immobilization element is engaged for latching with the first immobilization element, and a second unlatched position in which the second immobilization element is not engaged for latching with the first immobilization element, and wherein the immobilization device comprises:
a cam connected to the mobile rod of the main cylinder and a second immobilization element; or
a projecting part provided on the mobile rod of the main cylinder and coming into contact with the second immobilization element when said mobile rod is displaced into retracted position;
said cam or projecting part making the second immobilization element pivot into the latching position when the mobile rod of the cylinder is displaced into retracted position.

11. The road vehicle according to claim 9, wherein the first immobilization element is provided under the road vehicle and wherein the second immobilization element is provided in the upper part of the drawbar.

12. The road vehicle according to claim 9, wherein the first and second immobilization elements are for the one a claw or hook and for the other a hasp or hanger, where said first and second immobilization elements are intended to be engaged in mutual latching when the mobile rod of said drawbar is in retracted position.

13. The road vehicle according to claim 10, wherein the immobilization device comprises an elastic pushing or return device which constrains the second immobilization element in unlatching position.

14. The road vehicle according to claim 1, further comprising:
a drawbar at the front or rear end of the road vehicle and comprising a coupling part;
a coupling yoke provided at the other end of the road vehicle and comprising a complementary coupling part;
the coupling part of the road vehicle being able to mutually latch with a complementary coupling part of another road vehicle, and said complementary coupling part of the road vehicle being able to mutually latch with the coupling part of another road vehicle.

15. The road vehicle according to claim 14, further comprising a drawbar at the front and a coupling yoke at the rear.
